(19) United States
(12) Patent Application Publication
(10) Pub. No.: US 2005/0196541 A1
(43) Pub. Date: Sep. 8, 2005

(54) Method of manufacturing ink jet recording sheet

(75) Inventors: Shinichi Suzuki, Tokyo (JP); Keiji Ohbayashi, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Photo Imaging, Inc.

(21) Appl. No.: 11/067,059

(22) Filed: Feb. 25, 2005

(30) Foreign Application Priority Data
Mar. 5, 2004 (JP) JP2004-061927

(51) Int. Cl. B05D 3/02

(52) U.S. Cl. 427/402; 427/372.2

(57) ABSTRACT

A method for manufacturing ink jet recording sheet having the steps, in that order, of: providing an under-coat layer on a polyolefin coating support having the center-line average roughness of the surface of the polyolefin coated support of 0.10 to 1.5 μm as measured at a reference length of 2.5 mm and a cutoff value of 0.8 mm; heating the polyolefin coated support on which the under-coat layer is provided; and coating on the under-coat layer a coating liquid that contains inorganic micro particles and binder so that the coating liquid forms a porous ink absorption layer, wherein the temperature difference between the temperature of the polyolefin coated support and the temperature of the coating liquid is within 15° C. in the coating step.

### TECHNICAL FIELD

The present invention relates to a method of manufacturing photograph grade ink jet recording sheet containing a support coated with polyolefin resin on which is provided a porous ink absorption layer, and in particular to the method of manufacturing ink jet recording sheet during which the occurrence of liquid repelling defects at the time of coating on the support body a coating liquid containing a high density of inorganic micro particles and cracks are reduced.

### BACKGROUND

In recent years, the use of photograph grade ink jet recording sheet is increasing rapidly. In particular, ink jet recording sheet in which the support is a paper both sides of which are coated with polyolefin resins such as polyethylene etc., upon which is coated a porous ink absorption layer having high ink absorption speed is being used widely for prints with the appearance of high quality close to silver halide photographic materials because their cost is relatively low compared to plastic films and also because of their thick appearance, flexibility, smoothness, and glossiness, and a large number of ink jet recording sheets of this construction are very widely known.

For example, an ink jet recording sheet has been reported (for example, in Japanese Patent Application Laid Open No. Hei 8-174992) which contains a porous ink absorption layer comprising water soluble resin and silica particles with primary particle diameters of 10 nm or less on a support whose surface has a glossiness of 70% or more.

When using a support comprising a paper whose both surfaces are covered with a polyolefin resin in this manner, since the surface of the polyolefin resin is, in general, water repellant and also since the porous ink absorption layer is obtained by coating a water-based coating liquid, it is desirable to provide between these two layers an adhesion enhancement layer as the under-coat layer in order to improve adhesion, and such an example has been reported (for example, in Japanese Patent Application Laid Open No. 2000-351270) of an ink jet recording sheet with high glossiness and improved surface defects because of the use of a polyolefin resin coated paper provided with an under-coat layer having a solid component quantity of 0.5 g/m² or less in the coating as the support.

Further, an ink jet recording sheet has been reported (for example, in Japanese Patent Application Laid Open No. 2001-63203) which contains a glossy coated film without undulations in which the generation of spray unevenness is suppressed by providing an under-coat layer having a solubility of 60% or less in water at 50° C.

Hydrophilic polymers such as gelatin or polyvinyl alcohol (PVA) are used desirably as the under-coat layer because the porous ink absorption layer generally contains a hydrophilic binder such as polyvinyl alcohol etc., apart from which, various types of latex are also being used.

However, according to the results of investigations made by the present inventors and others, although certainly the adhesion is improved between the porous ink absorption layer and the support made of polyolefin resin coated paper by providing an under-coat layer on the polyolefin resin layer and also even the wetting by the coating liquid is improved, it has become clear that the elimination of the coating liquid repelling problem related to the wettability is not necessarily sufficient.

It is necessary to make the under-coat layer a very thin film with a dry film thickness of 1 μm or less, preferably 0.3 μm or less. Otherwise, the under-coat layer swells immediately after the porous ink absorption layer is coated, and when the under-coat layer gets contracted during the drying process of the porous ink absorption layer, reticulation coating defects are easy to occur in the porous film which is a hard layer.

Therefore, in such a support provided with a thin film under-coat layer, it is possible that there are pinhole shaped locations generated in which the under-coat layer is not coated on the surface of the polyolefin resin, or even if the support is coated completely there are locations where the coating is thin compared to the normal parts. The liquid repelling effect is likely to occur and the coating is likely to become defective when a coating liquid containing large amounts of inorganic micro particles is coated on such locations provided with the under-coat layer.

The liquid repelling defects and cracks are closely related. It is possible that there are the cracks generated on the liquid repelled part.

This problem becomes still more pronounced when the porous ink absorption layer is coated at a high speed, and it is desirable to reduce the liquid repelling defects and cracks which is generated by the liquid repelling defects from the point of view of manufacturing at a low cost and high productivity.

As a result of the investigation made by the present inventors regarding ink jet recording sheet having porous ink absorption characteristics provided in the aforesaid paper support covered with polyolefin resin, it has been found that the adhesion with the support is improved and also liquid repelling defects and cracks can be reduced even when the coating is made at a high speed by providing an under-coat layer on top of a polyolefin resin coated paper having a specific degree of surface smoothness and by making specific the relationship between the temperature of the support and the temperature of the coating liquid forming the porous ink absorption layer.

An aspect of the invention is a method of manufacturing ink jet recording sheet including the steps of:
providing an under-coat layer on a polyolefin coated support having the specific the center-line average roughness of the surface thereof;
heating the polyolefin coated support on which the under-coat layer is provided; and
coating on the under-coat layer a coating liquid that contains inorganic micro particles and binder so that the coating liquid forms a porous ink absorption layer; in that order,
wherein the temperature difference between the temperature of the polyolefin coated support and the temperature of the coating liquid is within the specific range in the coating step.

### DESCRIPTION OF THE PREFERRED EMBODIMENT

More details of the features of the present invention are described below.

(1) In a method of manufacturing ink jet recording sheet comprising a process of providing an under-coat layer on a polyolefin coated paper support, and a process of coating on top of that under-coat layer a coating liquid that contains inorganic micro particles and binder, which coating liquid forms a porous ink absorption layer; a method of manufacturing ink jet recording sheet with the feature that the center-line average roughness Ra of the surface of said polyolefin coated paper support is 0.10-1.5 μm as measured at a reference length of 2.5 mm and a cutoff value of 0.8 mm according to the stipulation in the standard JIS B 0601, the temperature of said support is raised before coating said porous ink absorption layer, and carrying out coating after making the temperature of said support to be within 15° C. of the temperature of the coating liquid that forms said porous ink absorption layer.

(2) A method of manufacturing ink jet recording sheet according to (1) above with the feature that the temperature of the coating liquid forming said porous ink absorption layer is in the range 35-50° C.

(3) A method of manufacturing ink jet recording sheet according to (1) or (2) above with the feature that the ratio of the specific gravity of said inorganic micro particles to the specific gravity of the binder is in the range 3-8.

(4) A method of manufacturing ink jet recording sheet according to any one of (1)-(3) above with the feature that the coating speed is 50-500 m per minute.

(5) A method of manufacturing ink jet recording sheet according to any one of (1)-(4) above with the feature that immediately after coating the temperature of the coated film is first lowered to 20° C. or less and then the coated film is dried by a hot air blast.

Because of the above configuration in the present invention, it is possible to provide a method of manufacturing ink jet recording sheet that not only improves the adhesion between the support and the porous ink absorption layer but also reduces the liquid repelling defects and cracks even when the porous ink absorption layer is coated at a high speed.

The present invention is described in further detail below.

The support used in the ink jet recording sheet according to the present invention is a paper support whose both sides of which are coated with polyolefin resin.

The paper used for the support according to the present invention can use wood pulp as the main raw material, and synthetic pulp such as polypropylene, etc., or synthetic fibers such as nylon or polyester are used in addition to wood pulp when necessary during the paper making process. It is possible to use any of LBKP, LBSP, NBKP, NBSP, LDP, NDP, LUKP, and NUKP as the wood pulp.

Chemical pulps (sulfate pulps or sulfite pulps) containing minimal impurities are employed preferably as the pulps mentioned above, and pulps whose whiteness has been increased by bleaching using ozone, chlorine based bleaching agents, or hydrogen peroxide, etc., can also be used.

It is possible to add to the above pulp appropriate quantities of sizing agents such as higher fatty acids, alkyl ketene dimers, etc., white pigments such as calcium carbonate, talc, titanium dioxide, etc., paper strength enhancing agents such as starch, polyacryl amide, polyvinyl alcohol, etc., fluorescent whiteness enhancing agents, humectants such as polyethylene glycol, dispersing agents, and softening agents such as quaternary ammonium compounds.

It is desirable that the freeness of the pulp used in papermaking is 200-500 ml as per the CSF standard, and also, the fiber length after refining should desirably be such that the sum of 24-mesh residue and 42-mesh residue as stipulated in the standard JIS P 8207 is 30-70%. Further, it is desirable that the 4-mesh residue is 20% or less.

It is desirable that the basis weight of paper is in the range of 50-250 g, and more desirably in the range of 80-200 g. It is desirable that the paper thickness is in the range of 70-210 μm.

It is also possible to give high smoothness to the paper by subjecting it to calendar processing either during or after papermaking. The paper density is generally in the range of 0.7-1.2 g/m³ (JIS P 8118). In addition, the stiffness of raw paper should desirably be in the range of 20-200 g under the conditions stipulated in the standard JIS P 8143.

It is possible to coat surface sizing agents on the paper surface and the same sizing agents as those used as additives in said raw paper can also be used as surface sizing agents.

The pH value of the paper should desirably be in the range of 5-9 when measured using the hot water extraction method stipulated in the standard JIS P 8113.

Next, the polyolefin resins coated on both sides of this paper are described below.

Although polyethylene, polypropylene, and polyisobutylene can be used as the polyolefin resins for this purpose, it is desirable to use the polyolefins that are copolymers comprised of ethylene or propylene as the main component, and among these, polyethylene is particularly desirable.

In the following, description is given regarding polyethylene which is particularly desirable to be used.

The types of polyethylene coated on the front and back surfaces of the paper are mainly low density polyethylene (LDPE) and/or high density polyethylene (HDPE), but other than these it is also possible to use partially LLDPE or polypropylene.

In particular, it is desirable that the polyolefin resin layer on the side on which the porous ink absorption layer is coated contains in it as an additive a rutile type or an anatase type titanium dioxide thereby improving the opacity and degree of whiteness of the layer. The content of titanium dioxide in the polyolefin should be roughly 1-20%, and more desirably be 2-15%.

It is possible to add a pigment with a high thermal resistance or a fluorescent whitening agent to the polyolefin resin layer in order to adjust the background whiteness.

The coloring pigments can be ultramarine blue, Prussian blue, cobalt blue, pthalocyanine blue, manganese blue, cerulean blue, tungsten blue, molybdenum blue, anthraquinone blue, etc.

The fluorescent whitening agents can be dialkylaminocoumarin, bisdimethylaminostilbene, bismethylaminostilbene, 4-alkoxy-1,8-napthalene dicarboxylic acid-N-alkylimide, bisbenzoxazolylethylene, and dialkylstilbene.

The amounts of polyolefin used for covering the paper at the front and back are selected so as to optimize the curling at low and high humidities after determining the thickness of the porous ink absorption layer and after providing a backing layer. Customarily, the thickness of the polyolefin resin layer is in the range of 12-40 μm on the porous ink absorption layer side, and in the range of 15-50 μm on the backing layer side. The ratio of the thickness of the polyolefin resin layer on the front and back sides should desirably be set so as to adjust the curling that differs depending on the type and thickness of the ink reception layer as well as on the thickness of the paper sheet at the core, and customarily, the ratio of the thickness of the polyolefin resin layer at the front to that at the back is roughly in the range of 2/1-1/3.

Further, it is preferable that the aforesaid paper support coated with polyolefin has the following characteristics from (1)-(7).

(1) The tensile strength as specified in the standard JIS P 8113 should preferably be 2-30 kg in the longitudinal direction and 1-20 kg in the lateral direction.

(2) The shear strength as specified in the standard JIS P 8116 should preferably be 10-200 g in the longitudinal direction and 20—-200 g in the lateral direction.

(3) The compression modulus of elasticity should preferably be at least 9.8 kN/cm².

(4) The opacity should be 80% or more and particularly preferably be in the range of 85—98% when measured according to the method specified in the standard JIS P 8138.

(5) The whiteness as specified in the standard JIS Z 8729, L* should preferably be in the range of 80-97, a* in the range of −3-+5, and b* in the range of −6-+6.

(6) The Clark stiffness of the support in the direction of transport of ink jet recording sheet should desirably be in the range 50-300 cm³/100.

(7) The moisture in the raw paper should desirably be 4-10% with respect to the core paper.

An under-layer is provided on the aforesaid polyolefin coated paper before coating the porous ink absorption layer. It is possible to use a hydrophilic polymer layer or a latex layer as the under-coat layer.

While it is possible to select and use appropriately a widely known hydrophilic polymer, as the hydrophilic polymer used in the under-coat layer, in concrete terms it is possible to use gelatin or gelatin derivatives, polyvinylalcohol or polyvinyl alcohol derivatives, polyvinylpyrrolidone, polyethyleneoxide, polyacrylamide, carboxymethyl cellulose, hydroxyethyl cellulose, starch or starch derivatives etc. Two or more types of these hydrophilic polymers can be used together.

Particularly desirably hydrophilic polymers are gelatin or gelatin derivatives, and polyvinylalcohol or polyvinylalcohol derivatives, out of which polyvinylalcohol or polyvinylalcohol derivatives are still more desirable.

The latex used in the under-coat layer can be styrene, acrylic acid or methacrylic acid, acrylic acid or methacrylic acid ester, malic acid, divinylbenzene, vinylchloride, vinyliden chloride, vinylether, vinylacetate, ethylene and butadiene etc.

Film hardening agents, surfactants, silane coupling agents, color adjustment agents, fluorescent whitening agents, matting agents, or pH adjustment agents can be used suitably within the under-coat layer.

It is desirable that the under-coat layer has water resistance particularly for the purpose of reducing reticule shaped coating defects of said porous ink absorption layer in the dried condition, and a latex under-coat layer and an under-coat layer comprising a hardened hydrophilic polymer layer are used desirably.

The hardness of the under-coat layer in the case of a hardened hydrophilic polymer layer should be such that the under-coat does not melt at the temperature of the coating liquid of the porous ink absorption layer.

It is desirable that the dried film thickness of the under-coat layer is roughly in the range of 0.01-0.5 μm. The covering of the support by the under-coat layer will not be sufficient when this thickness is less than 0.01 μm, and when this thickness is larger than 0.5 μm, reticule shaped coating defects are more likely to occur at the time of coating the porous ink absorption layer. The desirable dry film thickness of the under-coat layer is in the range of 0.02-0.3 μm.

While the aforementioned under-coat layer is provided on top of the polyolefin resin layer, before coating the under-coat layer it is desirable from the point of view of adhesion to carry out surface activation processing of the polyolefin resin layer such as plasma treatment, flame treatment, or corona discharge treatment.

Next, the porous ink absorption layer provided on the support is described below.

The porous ink absorption layer can be provided either on one side or on both sides of the support. In the latter case, the porous ink absorption layer provided on the two sides can be the same or different.

The porous ink absorption layer is formed comprising inorganic micro particles and a small quantity of hydrophilic binder.

Examples of inorganic micro particles are white inorganic pigments such as low density calcium carbonate, high density calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, synthetic non-crystalline silica, colloidal silica, alumina, colloidal alumina, pseudo-boehmite, aluminum hydroxide, lithopone, zeolite, magnesium hydroxide, etc. Such inorganic micro particles may be used in the form of primary particles without any modification or in a state in which secondary aggregated particles are formed.

In the present invention, because particularly minute voids are formed, it is desirable to use silica or pseudo-boehmite with an average particle diameter of 100 nm or less, in particular silica, colloidal silica, and pseudo-boehmite synthesized using vapor phase growth methods and with an average particle diameter of 100 nm or less are particularly desirable.

The average diameter of inorganic micro particles is determined by observing using an electron microscope the particles themselves or the cross-section or surface of porous ink absorption layer, obtaining the particle diameters of any randomly selected 100 particles, and by computing their simple average value (being a number average). Herein, each particle diameter is represented by the diameter of a circle which has the same area as the projected area of each individual particle of the aforesaid particle.

The hydrophilic binder used in the porous ink absorption layer can be gelatin (alkaline process gelatin, acidic process gelatin, gelatin derivatives in which the amino group is blocked by phenyl isocyanate or phthalic anhydride, etc.,), polyvinyl alcohol, polyvinylpyrrolidone, polyethylene oxides, hydroxylethylcellulose, agar, Pullulan, dextran, acrylic acid, carboxymethylcellulose, casein, and alginic acid, and it is also possible to use two or more of these materials in combination.

Particularly desirable hydrophilic polymers are polyvinyl alcohol and its derivatives.

Polyvinyl alcohols used preferably in the present invention include common polyvinyl alcohol prepared by hydrolyzing polyvinyl acetate, and also, modified polyvinyl alcohol such as cation-modified polyvinyl alcohol at the terminal as well as anion-modified polyvinyl alcohol having an anionic group.

Polyvinyl alcohols prepared by hydrolyzing vinyl acetate and having an average degree of polymerization of 300 or more are used preferably, and those having an average degree of polymerization of 1,000-5,000 are particularly preferable.

Further, polyvinyl alcohols having a saponification ratio of 70-100% are desirable and those having a saponification ratio of 80-100% are particularly desirable.

Further, a type of polyvinyl alcohol derivative described in Japanese Unexamined Patent Application Laid Open No. Hei 1-286886 and in which cross-linking is possible by the use of electrolyzing radiation is also a desirable hydrophilic polymer that can be used in the present invention.

The ratio of the hydrophilic binder to the micro particles in the porous ink absorption layer should broadly be in the range of 1:10-1:2, and should more preferably in the range of 1:8-1:3.

In addition, in cases when the aforementioned porous ink absorption layer includes polyvinyl alcohol as a hydrophilic binder, it is preferable that a film strengthening agent is incorporated in order to improve the film preparation characteristics of the layer and to enhance the strength of the layer. As such a film strengthening agent, it is desirable to use boric acid or salts thereof or epoxy type film strengthening agents, and it is particularly desirable to employ boric acid for this purpose.

Boric acids and salts thereof refer to oxygen based acids having a boron atom as the central atom and salts thereof, and specifically include-orthoboric acid, metaboric acid, hypoboric acid, tetraboric acid, and pentaboric acid, and salts thereof.

The quantity used of boric acids or salts thereof can vary widely depending on the quantities of inorganic micro particles and hydrophilic polymers in the coating liquid, but is commonly 1-60% by weight, and is preferably 5-40% by weight.

However, a film hardening agent is not necessarily required to be included when the hydrophilic binder used in the porous ink absorption layer is itself capable of cross-linking or is of a type which can be cross-linked by light irradiation such as ultraviolet ray irradiation, but it is desirable to use a film strengthening agent in order to maintain a high ink absorption speed.

It is possible to incorporate various additives other than those mentioned above in the porous ink absorption layer of the ink-jet recording sheet according to the present invention.

Among these, it is preferable to include cationic mordants in order to enhance water resistance and moisture resistance after printing. The cationic mordants used are polymer mordants having a primary, secondary, or tertiary amino group and a quaternary ammonium salt group. Among these, polymer mordants having a quaternary ammonium salt group are desirable since in their case discoloration with time and degradation of lightfastness over long periods of time are minimized, while the dye mordanting capability is sufficiently high.

Preferred polymer mordants are prepared in the form of homopolymers of monomers having the aforementioned quaternary ammonium salt group and copolymers with other monomers.

Concrete examples of cationic mordants are given in the book “Ink jet printer technology and materials”, p. 268 (in Japanese) (published by CMC Co., Ltd., 1998).

Apart from the additives mentioned above, it is possible to incorporate various additives known in the art, such as UV absorbers described in Japanese Unexamined Patent Application Laid Open Nos. Sho 57-74193, Sho 57-87988, and Sho 62-261476; anti-discoloring agents described in Japanese Unexamined Patent Application Laid Open Nos. Sho 57-74192, Sho 57-87989, Sho 60-72785, Sho 61-146591, Hei 1-95091, and Hei 3-13376; various anionic, cationic, nonionic, and amphoteric surfactants, fluorescent whitening agents described in Japanese Unexamined Patent Application Laid Open Nos. Sho 59-42993, Sho 59-52689, Sho 62-280069, Sho 61-242871, and Hei 4-219266; white background color adjustment agents, water-soluble multi-valent metal compounds such as chlorine radical type poly-aluminum hydroxide or zirconyl acetate; antifoaming agent; lubricants such as diethylene glycol; antiseptic agents, thickeners; antistatic agents; matting agents, and pH adjustment agents, etc.

The dry film thickness of the aforementioned porous ink absorption layer is broadly 25-50 μm, and 50-80% of this dried film thickness should be voids or more preferably 55-75% should be voids. The porous ink absorption layer can be a single layer or can comprise two or more layers. When two are more layers are present, they can be either the same or can be different.

Next, the surface characteristics of the support of the ink jet recording sheet according to the present invention are described below.

From the point of view of suppressing liquid repelling defects at the time of coating, it is necessary that the surface of the polyolefin coated sheet on the porous ink absorption layer side has a center-line average roughness Ra is 0.10-1.5 μm as measured at a reference length of 2.5 mm and a cutoff value of 0.8 mm according to the stipulation in the standard JIS B 0601.

The center line mean roughness (Ra) in the sense in which it is used in the present invention can be defined according to JIS-B-0601 as Ra. To be more specific, the center line mean roughness (Ra) is defined as the value obtained from the following equation expressed in micrometers (μm) when a measured length L is extracted from a roughness curve along the centerline; where X axis indicates the centerline of the extracted portion, Y axis shows the direction of longitudinal magnification and Y=f(X) denotes the roughness curve, and the cutoff value is 0.8 mm.

$$Ra = \frac{1}{L} {\int }_{0}^{L} \vert f ( x ) \vert ⅆ x$$

When Ra is less than 0.10 μm, relatively large-sized liquid repelling defects are likely to occur. On the other hand, if Ra exceeds 1.5 μm, although there is no increase in the liquid repelling defects per se, cracks are more likely to occur in the porous ink absorption layer.

The desirable range of values of Ra depend also on the surface quality of the paper, and Ra should be in the range of 0.10-0.30 μm when the paper is glossy, more preferably in the range of 0.12-0.20 μm. When the paper has a silky or matt surface, Ra should be in the range of 0.30-1.5 μm, more preferably in the range of 0.5-1.3 μm.

It is possible to use various types of surface qualities of porous ink absorption layers of polyolefin resin coated sheets, such as matt surfaces and silky surfaces other than glossy surfaces, as long as the Ra is in the aforementioned range.

The 75-degree mirror surface glossiness of the surface of the polyolefin resin coated sheet on the side of the porous ink absorption layer should desirably be 40-90% in the case of glossy sheets, and 10-60% when the paper surface quality is matt or silky, and also the 10-point average roughness should desirably be 0.15-0.5 μm in the case of glossy sheets and 0.8-5.0 μm in the case matt or silky sheet surfaces.

Regarding the value of Ra after coating the under-coat layer although it is not affected greatly because the under-coat layer is thin and the thickness of the under-coat layer is particularly within the desirable range (0.02-0.3 μm), roughly the value of Ra should be in the range of 0.08-1.4 μm.

The 75-degree mirror surface glossiness of the surface of the porous ink absorption layer of the ink jet recording sheet according to the present invention should be 40% or more and desirably be 50% or more in the case of glossy sheets, and 20-40% when the paper surface quality is silky, and 15-30% when the paper surface is matt.

Next, the methods of coating the under-coat layer and the porous ink absorption layer are described below.

The coating of the under-coat layer is done by coating the coating liquid forming the under-coat layer on the running polyolefin resin coated paper and then drying for a period of few seconds to one minute at 30-150° C. and more preferably at 40-120° C.

The coating of the under-coat layer can be done employing the methods of air knife coater, gravure coater, roll coater, wire bar coater, blade coater, bar coater, slide hopper coater, and curtain coater etc.

The dryers that can be used are hot air dryers such as air loop dryer, straight tunnel dryer, arch dryer etc., infrared dryer, and dryers using microwaves etc.

The coating method of porous ink absorption layer can be, for example, roll coating method, rod bar coating method, air knife coating method, spray coating method, curtain coating method, or extrusion coating method using a hopper as described in U.S. Pat. No. 2,681,294. The curtain coating method or the extrusion coating method is used desirably since it is desirable to coat porous films with high wet thicknesses.

It is desirable that the coating liquid of the porous ink absorption layer is at a temperature of 35-50° C. When the temperature is less than 35° C., gel formation occurs on the surface of the loading liquid because of containing a large quantity of inorganic micro particles thereby becoming a cause of coating defects, or causes problems in stable production because of rise in the viscosity due to reduction in the temperature in a localized region within the piping.

Particularly, when the coating liquid forming the porous ink absorption layer is a liquid whose viscosity rises relatively largely at low temperatures, it is suitable for high speed coating because, after coating, it is possible to dry it not only by merely heating it but also by blowing strong air blast on it. Such a coating liquid, for example, is one that has a viscosity at 15° C. that is 20 or more times the viscosity of the coating liquid at 40° C., and more preferably 100 or times the viscosity. Using such a coating liquid having increased viscosity at low temperatures leads to a pronounced effect of the present invention because liquid repelling defects are easier to occur when there is a large difference in the temperature of the support and the temperature of the coating liquid.

On the other hand, it is not desirable that the temperature of the coating liquid exceeds 50° C., because in that case the increase in the viscosity of the coating liquid is large while the coating liquid is stagnating. The particularly desirable temperature of the coating liquid is in the range of 37-47° C.

In the method of manufacturing ink jet recording sheets according to the present invention, in order to reduce liquid repelling defects it is necessary to heat and raise the temperature of the under-coated support at the time of coating the aforementioned porous ink absorption layer so that the difference between the temperatures of the coating liquid and the support is less than or equal to 15° C.

The liquid repelling defects can be reduced by making small the difference between the temperature of the support and the temperature of the coating liquid. Although the reason for this is not very clear, it is considered that when the temperature difference with the support is large, this is due to a local rise in the viscosity instantaneously when the coating liquid containing a high density of inorganic micro particles comes into contact with the support.

The preferable difference between the temperature of the support and the temperature of the coating liquid is 12° C. or less. Although there is no particular restriction if the rise in the temperature of the support is within the aforementioned range, a range of 30° C.-40° C. is desirable from the point of view of increasing the temperature at a high rate within a short span of time, and a range of 33° C.-40° C. is particularly desirable. It is also possible to make the temperature of the support higher than the temperature of the coating liquid. The time of increasing the temperature of the support is desirable to be synchronized with the coating of the porous ink absorption layer and the raising of the temperature of the support should desirably be done immediately before coating.

Raising the temperature of the support, preferably, is carried out by providing a support heater zone before the coater, and by passing the support through that zone. A plurality of various types of heating means such as heating rollers or infrared heaters are provided in the heating zone, and these are used either independently or together. In addition, it is also possible to blow hot air in combination with these. Normally, it is desirable to pass the support through the heating zone over a period of several seconds to about 10 seconds.

Further, at the time of coating the porous ink absorption layer, it is also possible at the same time to apply a high voltage (0.4-about 2 kV) to the backup roller supporting the support, or, to supply a current at a high voltage thereby stabilizing the coating (for example, as in Japanese Unexamined Patent Application Laid Open Nos. Sho 49-7050, Sho 63-4881, etc.).

While the method of coating the porous ink absorption is as described above, normally, a coating liquid viscosity in the range of 0.040-1.000 Pa·s is in common use, and a coating liquid viscosity in the range of 0.050-0.500 Pa·s is particularly desirable. Here, the viscosity is a value measured using a type B viscometer. The simultaneous coating method is desirable in which all the porous ink absorption layers are coated at the same time. Although, the thickness of the coating depends on the dry film thickness it is generally 3-6 times the dry film thickness coating and the coating is usually carried out in the range of 3-5 times. Normally, the wet film thickness is in the range of 100-250 μm.

The coating speed is generally in the range of 10-1000 m/min., although it depends on the drying capacity or the length of the drying zone, the method of the present invention is particularly suitable for high speed coating and the effect of reducing liquid repelling defects is particularly large when high speed coating is done at 50 m/min. or more, and the effect of the present invention is particularly large when high speed coating is done in the range of 50-500 m/min.

The normally used drying conditions can be used for the drying after coating, which is normally done at 20-80° C. After coating, the method of drying by first cooling and gelatinizing or making the coating liquid highly viscous is suitable for high speed coating because even if it is blown by a strong air blast there is very little likelihood of liquid getting collected at one side or of generating blow striations.

After coating the porous ink absorption layer using such a coating liquid, it is cooled first so that the film surface temperature becomes less than or equal to 20° C. and is then dried by a high temperature air blast whereby it is possible to obtain good coated film quality with reduced blow striations.

Because polyolefin resin coated paper is used as a support, the maximum temperature of the air blast used for drying should be 90° C. or less and in particular 80° C. or less is desirable from the point of view of heat resistance of the polyolefin resin.

In the ink jet recording sheet according to the present invention, it is possible to provide various types of backing layers on the side of the sheet opposite to that of the porous ink absorption layer for improving the effects of preventing curling or sticking or transfer of ink when the sheets are stacked one upon the other immediately after printing.

While the constitution of the backing layer varies depending on the type or thickness of the support, and on the constitution and thickness on its front side, in general, hydrophilic binder or water repelling binder are used for this purpose. The thickness of the backing layer is normally in the range of 0.1-10 am.

Furthermore, it is possible to add conductive material to the backing layer in order to improve the electrostatic charging characteristics, or can be subjected to surface roughening treatment in order to prevent the ink jet recording sheet from sticking to other ink jet recording sheets, to improve ease of writing on it using pens, pencils, or other writing equipment, and also to improve the characteristics of transporting the paper within an equipment. It is desirable to use organic or inorganic micro particles with a particle diameter of 0.5-20 μm as the additives for this purpose.

Although it is also possible to provide such backing layers after coating the porous ink absorption layer, it is desirable to provide the backing layer beforehand.

### EXAMPLES

The present invention is described in detail below with reference to some examples. However, the embodiments of the present invention shall not be construed to be limited to these examples. Further, the symbol “%” in the examples refers to absolute dry % by weight unless specified otherwise

### Preferred Embodiment 1

Preparation of Coating Liquid for the Porous Ink Absorption Layer:

(Preparation of Silica Dispersed Liquid B)

We prepared Solution A with the following composition:

| | | |
|---|---|---|
| Water | 1420 | L |
| Boric acid | 5.4 | kg |
| Boric sand | 4.8 | kg |
| Ethyl alcohol | 44 | L |
| Cation polymer (P - 1) 25% aqueous solution | 340 | L |
| Discoloration prevention agent (AF1) 10% | 17 | L |
| aqueous solution | | |
| Fluorescent whitening agent aqueous solution (W1 *) | 2.0 | L |
| Anti-foaming agent (Type SN381 manufactured | 200 | g |
| by Sun Nobco K.K.) | | |

The entire quantity is completed using 2000 liters of de-ionized water.

(W1*) UVITEX NFW LIQUID manufactured by Chiba Specialty Chemicals Limited
AF1: (HO—CH₂CH₂—S—CH₂—)²

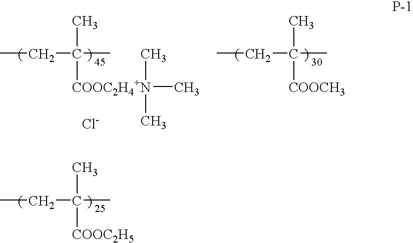

Prepared 400 kg of vapor phase grown silica micro particles (average primary particle diameter≈12 nm). Equal quantities of silica powder and the solution A were supplied and mixed continuously, and after carrying out preliminary dispersion by sufficiently mixing the two, according to the dispersion method described in Preferred Embodiment 5 of Japanese Unexamined Patent Application Laid Open No. 2002-47454, they were dispersed continuously using a sand mill dispersing equipment. A clear silica dispersed solution B was obtained by carrying out further dispersion using a high pressure homogenizer. At this time, the work was carried out while adjusting the flow rate so that 4.7 liters of solution A was used for every 1 kg of silica powder. The dispersion was carried out continuously while cooling at all times so that the maximum temperature of the dispersed liquid was 50° C. or less during sand mill dispersion and high pressure dispersion.

Adjustment was made by adding de-ionized water so that the silica density in the obtained dispersed liquid was finally 18% by volume per every liter of the dispersed liquid. The pH of the obtained silica dispersed liquid was 4.5.

Preparation of the Coating Liquid:

A coating liquid C with the following composition was prepared using the dispersed liquid B obtained as explained above. The following values of constituents in the coating liquid are for 1 liter of the coating liquid.

| | | |
|---|---|---|
| Silica dispersed liquid B | 440 | ml |
| De-ionized water | 300 | ml |
| 8% Aqueous solution of polyvinyl alcohol (1:1 mixture | 200 | ml |
| of PVA 235/245 manufactured by Kuraray Co., Ltd.) | | |
| Aqueous solution of saponin (5%) | 20 | ml |
| Surfactant (5% solution of SF-1) | 5.5 | ml |
| Ethyl alcohol | 25 | ml |

Added de-ionized water to make up 1000 ml.

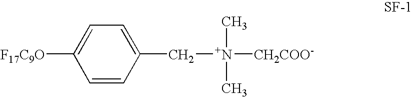

The coating liquid so obtained was filtered using a filter (50% collection efficiency was 20 μm). The viscosity of the coating liquid obtained by filtering at 40° C. was 0.030 Pa·s and at 15° C. was 1.200 Pa·s.

Preparation of the Support:

The bottom surface of a raw paper for photographs (LBKP/NBSP=50/50, raw paper water content of 8%) whose both surfaces have been subjected to surface size-pressing treatment and which has a basis weight of 170 g/m² was coated with a layer of low density polyethylene and high density polyethylene (50/50) using the melt extrusion coating method to obtain a film thickness of 33 μm. Next, a layer containing low density polyethylene, high density polyethylene, and anatase type titanium dioxide (70/26/4) was coated in a similar manner to obtain a film thickness of 27 μm on the top surface of the paper thereby preparing support coated on both surfaces with polyethylene. Immediately after coating the top surface in the melt extrusion coating method, the top surface is cooled and the polyethylene surface is made rolled using four types of cooling rolls with different roughnesses thereby obtaining a glossy polyethylene coated paper support in which the polyethylene surface has four different types of Ra values.

After carrying out corona discharge on the bottom surface of the polyethylene coated sheet, a back layer was coated with styrene-malic acid type latex, cation polymer (antistatic agent, 5% by weight of solid latex component), and silica with a particle diameter of 0.2 μm (matting agent, 10% by weight of solid latex component), so as to obtain finally fully dried solid component of 0.2 g/m².

On the other hand, the top surface of the support is provided with an under-coat layer comprising gelatin (0.05 g for every 1 m² of the support) film stiffener (for every 1 g of gelatin 0.01 g of 2,4-dichloro-6-hydroxy-s-triazine), and surfactant (SF-2, 5% by weight of gelatin). The coating of the back layer and the under-coat layer are both done using the gravure method.

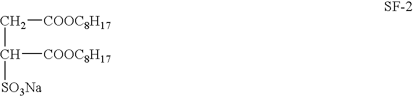

The surface characteristics of the top and bottom surfaces of the support are shown in Table 1.

TABLE 1

| | Top surface | | | | | | | |
|---|---|---|---|---|---|---|---|---|
| | Before | | | | | | | |
| | undercoating | | | After | Bottom surface | | | |
| | | | 75° | undercoating | | | 75° | Beck |
| Support | Ra | Rz | glossiness | Ra | Ra | Rz | glossiness | Smoothness |
| RC-1 | 0.07 | 0.22 | 81 | 0.06 | 1.24 | 3.08 | 23 | 410 |
| RC-2 | 0.11 | 0.25 | 68 | 0.1 | | | | |
| RC-3 | 0.14 | 0.38 | 54 | 0.12 | | | | |
| RC-4 | 0.18 | 0.41 | 39 | 0.17 | | | | |

Rz: Ten-point average roughness

The ten-point mean roughness (Rz) be defined according to the JIS-B-0601 that stipulates the surface roughness. The ten-point mean roughness (Rz) is defined as follows: In the portion obtained by extracted the reference length from the sectional curve, a difference expressed in micrometers (μm) between:
the mean value of the elevations of the peaks from the highest point to the 5th highest point, as measured in the direction of longitudinal magnification from the straight line, parallel to the mean line, without crossing the sectional curve; and
the mean value of the evaluation of the valleys from the lowest point to the fifth lowest point.
   Preparation of Ink Jet Recording Paper:

The aforementioned coating liquid C was coated using a slide hopper type coating apparatus on said four types of polyolefin resin coated sheet provided with undercoat so that the wet film thickness is 200 μm.

The coating was done on a 1.5 m wide support that is moving continuously at a rate of 100 m/min with a coating liquid temperature of 40° C. The coated sheet is cooled for 30 seconds immediately after coating in a cooling zone maintained at 5° C., and is then dried by blowing respective drying air blasts for 60 seconds in the first zone (20-30° C., relative humidity of 20% or less), 120 seconds in the second zone (45° C., relative humidity of 10% or less), and 120 seconds in the third zone (50° C., relative humidity of 20% or less), after that the humidity of the sheet is adjusted for about 2 minutes at 23° C. and relative humidity of 40-60% and is then wound in the shape of a roll. Further, the sheet is stored in a heated condition in the shape of the roll for five days in a 40° C. warehouse.

Further, a heating zone of about 30 m length is provided immediately before the coater in which are placed four types of supporting bodies whose temperature is adjusted as shown in Table 2 by means of about 30 heating rollers and hot air blast. When the support temperature is indicated as 22° C., it refers to the case in which the support temperature was not raised.

The temperature of the support is measured immediately before the coater using a non-contacting type thermometer.

A high voltage of about 1.2 kV was applied to the backup roller supporting the support at the time of coating.

(Evaluation of the Ink Jet Recording Sheet)

Fifty meters of the ink jet recording sheet prepared in the above manner was studied and the number of occurrences of liquid repelling defects for every 10 m was determined.

Further, visual evaluation was done of the number of cracks in 1 m of the ink jet recording sheet. The results are shown in Table 2.

TABLE 2

| | | Temperature | | | |
|---|---|---|---|---|---|
| | | difference | Number of | | |
| | Support | between coating | liquid | | |
| | temper- | liquid and | repelling | | |
| Support | ature | support | defects | Cracks | Remarks |
| RC-1 | 22° C. | (ΔT = 18) | 4.2 | 1 | Comparative |
| | | | | | Example |
| | 30° C. | (ΔT = 10) | 2.4 | 1 | Comparative |
| | | | | | Example |
| | 38° C. | (ΔT = 2) | 2.6 | 0 | Comparative |
| | | | | | Example |
| | 45° C. | (ΔT = 5) | 2.2 | 1 | Comparative |
| | | | | | Example |
| RC-2 | 22° C. | (ΔT = 18) | 3.4 | 1 | Comparative |
| | | | | | Example |
| | 30° C. | (ΔT = 10) | 0.2 | 0 | Present |
| | | | | | Invention |
| | 38° C. | (ΔT = 2) | 0.0 | 0 | Present |
| | | | | | Invention |
| | 45° C. | (ΔT = 5) | 0.2 | 1 | Present |
| | | | | | Invention |
| RC-3 | 22° C. | (ΔT = 18) | 2.4 | 2 | Comparative |
| | | | | | Example |
| | 30° C. | (ΔT = 10) | 0.0 | 0 | Present |
| | | | | | Invention |
| | 38° C. | (ΔT = 2) | 0.2 | 1 | Present |
| | | | | | Invention |
| | 45° C. | (ΔT = 5) | 0.0 | 0 | Present |
| | | | | | Invention |
| RC-4 | 22° C. | (ΔT = 18) | 2.0 | 2 | Comparative |
| | | | | | Example |
| | 30° C. | (ΔT = 10) | 0.2 | 1 | Present |
| | | | | | Invention |
| | 38° C. | (ΔT = 2) | 0.0 | 0 | Present |
| | | | | | Invention |
| | 45° C. | (ΔT = 5) | 0.0 | 0 | Present |
| | | | | | Invention |

From the results shown in Table 2, it is clear that using a support in which Ra is within the range of 0.10-1.5 μm as per the present invention and also by making the difference between the temperature of the support and the temperature of the coating liquid equal to or less than 15° C. the number of liquid repelling defects has been reduced to less than 1 point in 10 m.

### Preferred Embodiment 2

The coating liquid D was obtained in a manner similar to that in preferred embodiment 1 except that the composition of the coating liquid has been changed to that given below:

| | | |
|---|---|---|
| Silica dispersed liquid B | 520 | ml |
| De-ionized water | 170 | ml |
| 8% Aqueous solution (by weight/volume) of | 236 | ml |
| polyvinyl alcohol (1:1 mixture of PVA 235/245 | | |
| manufactured by Kuraray Co., Ltd.) | | |
| Aqueous solution of saponin (5%) | 20 | ml |
| Surfactant (5% solution of SF-1) | 5.5 | ml |
| Ethyl alcohol | 25 | ml |

Added de-ionized water to make up 1000 ml.

The coating liquid so obtained was filtered similar to Preferred Embodiment 1 using a filter (50% collection efficiency was 20 μm). The viscosity of the coating liquid obtained by filtering at 40° C. was 0.065 Pa·s and at 15° C. was 45 Pa·s.

Similar to Preferred Embodiment 1, coating was done using four types of supporting bodies so that the wet film thickness becomes 169 μm. At this time the temperature of the support and the temperatures and humidities of the drying air blasts were the same as those in the Preferred Embodiment 1, but since the coating speed was 120 m/min, the respective persistence durations in the different drying chambers were 1/1.2 of the values given in the Preferred Embodiment 1. Evaluation was conducted in a manner similar to that in Preferred Embodiment 1 and the results shown in Table 3 were obtained.

TABLE 3

| | | Temperature | | | |
|---|---|---|---|---|---|
| | | difference | Number of | | |
| | Support | between coating | liquid | | |
| | temper- | liquid and | repelling | | |
| Support | ature | support | defects | Cracks | Remarks |
| RC-1 | 22° C. | (ΔT = 18) | 7.0 | 1 | Comparative |
| | | | | | Example |
| | 30° C. | (ΔT = 10) | 2.4 | 2 | Comparative |
| | | | | | Example |
| | 38° C. | (ΔT = 2) | 2.2 | 1 | Comparative |
| | | | | | Example |
| | 45° C. | (ΔT = 5) | 2.4 | 1 | Comparative |
| | | | | | Example |
| RC-2 | 22° C. | (ΔT = 18) | 4.8 | 1 | Comparative |
| | | | | | Example |
| | 30° C. | (ΔT = 10) | 0.6 | 1 | Present |
| | | | | | Invention |
| | 38° C. | (ΔT = 2) | 0.4 | 0 | Present |
| | | | | | Invention |
| | 45° C. | (ΔT = 5) | 0.0 | 1 | Present |
| | | | | | Invention |
| RC-3 | 22° C. | (ΔT = 18) | 4.4 | 2 | Comparative |
| | | | | | Example |
| | 30° C. | (ΔT = 10) | 0.2 | 0 | Present |
| | | | | | Invention |
| | 38° C. | (ΔT = 2) | 0.2 | 0 | Present |
| | | | | | Invention |
| | 45° C. | (ΔT = 5) | 0.2 | 0 | Present |
| | | | | | Invention |
| RC-4 | 22° C. | (ΔT = 18) | 4.6 | 3 | Comparative |
| | | | | | Example |
| | 30° C. | (ΔT = 10) | 0.2 | 1 | Present |
| | | | | | Invention |
| | 38° C. | (ΔT = 2) | 0.0 | 1 | Present |
| | | | | | Invention |
| | 45° C. | (ΔT = 5) | 0.0 | 0 | Present |
| | | | | | Invention |

From the results shown in Table 3 it is clear that when the viscosity of the coating liquid is increased thereby increasing the viscosities at low temperatures although the resistance to liquid repelling defects has decreased compared to Preferred Embodiment 1, even in that case it is possible to obtain good resistance to liquid repelling defects if the temperature of the support is raised so that its difference with the temperature of the coating liquid is made 15° C. or less.

### Preferred Embodiment 3

At the time of manufacturing polyethylene coated paper support used in the Preferred Embodiment 1, cooling rollers that give a silky texture with four different types of roughnesses on the top surface are used thereby obtaining a polyethylene coated paper support for silky-surfaced having four different types of Ra values on the surface of the polyethylene coating while cooling it. The surface characteristics of the support are shown in Table 4.

TABLE 4

| | Top surface | | | | | | | |
|---|---|---|---|---|---|---|---|---|
| | Before | | | | | | | |
| | undercoating | | | After | Bottom surface | | | |
| | | | 75° | undercoating | | | 75° | Beck |
| Support | Ra | Rz | glossiness | Ra | Ra | Rz | glossiness | Smoothness |
| RC-1E | 0.89 | 2.11 | 38 | 0.83 | 1.25 | 3.11 | 22 | 390 |
| RC-2E | 1.23 | 3.17 | 28 | 1.14 | | | | |
| RC-3E | 1.42 | 4.03 | 19 | 1.36 | | | | |
| RC-4E | 1.85 | 5.22 | 11 | 1.79 | | | | |

An ink jet recording sheet was prepared in a manner similar to that used in the Preferred Embodiment 2 using the coating liquid D prepared in the Preferred Embodiment 2, and the results shown in the Table 5 were obtained.

TABLE 5

| | | Temperature | | | |
|---|---|---|---|---|---|
| | | difference | Number of | | |
| | Support | between coating | liquid | | |
| | temper- | liquid and | repelling | | |
| Support | ature | support | defects | Cracks | Remarks |
| RC-1E | 22° C. | (ΔT = 18) | 3.2 | 1 | Comparative |
| | | | | | Example |
| | 30° C. | (ΔT = 10) | 0.2 | 1 | Present |
| | | | | | Invention |
| | 38° C. | (ΔT = 2) | 0.0 | 0 | Present |
| | | | | | Invention |
| | 45° C. | (ΔT = 5) | 0.2 | 1 | Present |
| | | | | | Invention |
| RC-2E | 22° C. | (ΔT = 18) | 2.8 | 2 | Comparative |
| | | | | | Example |
| | 30° C. | (ΔT = 10) | 0.2 | 0 | Present |
| | | | | | Invention |
| | 38° C. | (ΔT = 2) | 0.0 | 1 | Present |
| | | | | | Invention |
| | 45° C. | (ΔT = 5) | 0.0 | 0 | Present |
| | | | | | Invention |
| RC-3E | 22° C. | (ΔT = 18) | 2.4 | 2 | Comparative |
| | | | | | Example |
| | 30° C. | (ΔT = 10) | 0.0 | 1 | Present |
| | | | | | Invention |
| | 38° C. | (ΔT = 2) | 0.2 | 0 | Present |
| | | | | | Invention |
| | 45° C. | (ΔT = 5) | 0.2 | 0 | Present |
| | | | | | Invention |
| RC-4E | 22° C. | (ΔT = 18) | 2.2 | 11 | Comparative |
| | | | | | Example |
| | 30° C. | (ΔT = 10) | 0.2 | 8 | Comparative |
| | | | | | Example |
| | 38° C. | (ΔT = 2) | 0.0 | 6 | Comparative |
| | | | | | Example |
| | 45° C. | (ΔT = 5) | 0.0 | 7 | Comparative |
| | | | | | Example |

From the results of Table 5 it can be seen that even when the surface quality is changed to silky it is possible to improve resistance to liquid repelling defects by following the method of manufacture according to the present invention. However, the number of cracks increases when the support RC-4E is used in which surface roughness Ra is more than 1.5 μm.

### Preferred Embodiment 4

The Preferred Embodiment 2 was repeated except that the coating speed was made 180 m/min and the drying conditions were changed as given below, and the liquid repelling defects of the ink jet recording sheet were evaluated.

Drying Conditions: The coated sheet is cooled for 20 seconds in the cooling zone, and is then dried by blowing respective drying air blasts for 40 seconds in the first zone (30-40° C., relative humidity of 20% or less), 80 seconds in the second zone (65° C., relative humidity of 10% or less), and 80 seconds in the third zone (55° C., relative humidity of 20% or less), after that the humidity of the sheet is adjusted for about 80 seconds at 23° C. and relative humidity of 40-60% and is then wound in the shape of a roll. The results obtained are shown in Table 6.

TABLE 6

| | | Temperature | | |
|---|---|---|---|---|
| | | difference | Number of | |
| | | between | liquid | |
| | Support | coating liquid | repelling | |
| Support | temperature | and support | defects | Remarks |
| RC-1 | 22° C. | (ΔT = 18) | 12.2 | Comparative |
| | | | | Example |
| | 30° C. | (ΔT = 10) | 4.8 | Comparative |
| | | | | Example |
| | 38° C. | (ΔT = 2) | 3.6 | Comparative |
| | | | | Example |
| | 45° C. | (ΔT = 5) | 4.0 | Comparative |
| | | | | Example |
| RC-2 | 22° C. | (ΔT = 18) | 9.6 | Comparative |
| | | | | Example |
| | 30° C. | (ΔT = 10) | 0.8 | Present |
| | | | | Invention |
| | 38° C. | (ΔT = 2) | 0.6 | Present |
| | | | | Invention |
| | 45° C. | (ΔT = 5) | 0.6 | Present |
| | | | | Invention |
| RC-3 | 22° C. | (ΔT = 18) | 8.6 | Comparative |
| | | | | Example |
| | 30° C. | (ΔT = 10) | 0.4 | Present |
| | | | | Invention |
| | 38° C. | (ΔT = 2) | 0.2 | Present |
| | | | | Invention |
| | 45° C. | (ΔT = 5) | 0.2 | Present |
| | | | | Invention |
| RC-4 | 22° C. | (ΔT = 18) | 8.0 | Comparative |
| | | | | Example |
| | 30° C. | (ΔT = 10) | 0.2 | Present |
| | | | | Invention |
| | 38° C. | (ΔT = 2) | 0.2 | Present |
| | | | | Invention |
| | 45° C. | (ΔT = 5) | 0.2 | Present |
| | | | | Invention |

From the results of Table 6, it is clear that when the coating speed is increased although the resistance to liquid repelling defects has decreased compared to Preferred Embodiment 2 in which the coating speed is slow, even in that case it is possible to obtain good resistance to liquid repelling defects if the temperature of the support is raised so that its difference with the temperature of the coating liquid is made 15° C. or less.

### Preferred Embodiment 5

Ink jet recording sheet was prepared in a manner similar to the Preferred Embodiment 2, except that the coating method was changed to the curtain coating method and the coating speed was changed to 240 m/min and the drying conditions were changed as given below, and the liquid repelling defects of the ink jet recording sheet were evaluated.

Drying Conditions: The coated sheet is cooled for 15 seconds in the cooling zone, and is then dried by blowing respective drying air blasts for 30 seconds in the first zone (35-45° C., relative humidity of 20% or less), 60 seconds in the second zone (75° C., relative humidity of 10% or less), and 60 seconds in the third zone (55° C., relative humidity of 20% or less), after that the humidity of the sheet is adjusted for about 80 seconds at 23° C. and relative humidity of 40-60% and is then wound in the shape of a roll. The results obtained are shown in Table 7.

TABLE 7

| | | Temperature | | |
|---|---|---|---|---|
| | | difference | Number of | |
| | | between | liquid | |
| | Support | coating liquid | repelling | |
| Support | temperature | and support | defects | Remarks |
| RC-1 | 22° C. | (ΔT = 18) | 28.4 | Comparative |
| | | | | Example |
| | 30° C. | (ΔT = 10) | 8.2 | Comparative |
| | | | | Example |
| | 38° C. | (ΔT = 2) | 5.4 | Comparative |
| | | | | Example |
| | 45° C. | (ΔT = 5) | 4.8 | Comparative |
| | | | | Example |
| RC-2 | 22° C. | (ΔT = 18) | 19.8 | Comparative |
| | | | | Example |
| | 30° C. | (ΔT = 10) | 1.0 | Present |
| | | | | Invention |
| | 38° C. | (ΔT = 2) | 0.6 | Present |
| | | | | Invention |
| | 45° C. | (ΔT = 5) | 0.6 | Present |
| | | | | Invention |
| RC-3 | 22° C. | (ΔT = 18) | 12.6 | Comparative |
| | | | | Example |
| | 30° C. | (ΔT = 10) | 0.6 | Present |
| | | | | Invention |
| | 38° C. | (ΔT = 2) | 0.4 | Present |
| | | | | Invention |
| | 45° C. | (ΔT = 5) | 0.4 | Present |
| | | | | Invention |
| RC-4 | 22° C. | (ΔT = 18) | 10.4 | Comparative |
| | | | | Example |
| | 30° C. | (ΔT = 10) | 0.6 | Present |
| | | | | Invention |
| | 38° C. | (ΔT = 2) | 0.4 | Present |
| | | | | Invention |
| | 45° C. | (ΔT = 5) | 0.4 | Present |
| | | | | Invention |

From the results of Table 7, it is clear that effects similar to those in Preferred Embodiment 5 are obtained even when the coating speed is increased, higher speed coating is possible using the manufacturing method according to the present invention.

### Preferred Embodiment 6

Preparation of Titanium Dioxide Dispersion Liquid 1:

An uniform Titanium Oxide Dispersion 1 was prepared by adding 20 kg of titanium oxide (having an average particle diameter of 0.25 μm, Type W-10 manufactured by Ishihara Sangyo Kaisha Ltd.) to 90 liters of an aqueous solution containing 150 g of sodium tripolyphosphate at a pH of 7.5, 500 g of polyvinyl alcohol (PVA235, manufactured by Kuraray Co., Ltd.), 150 g of a cationic polymer (p-1), and 10 g of antifoaming agent SN381, manufactured by Sun Nobco K.K.), and the resulting mixture was dispersed employing a high pressure homogenizer (manufactured by Sanwa Industry Co., Ltd.). Thereafter, the total volume was brought to 100 liters.

Preparation of Silica Dispersion Liquid F:

| | | |
|---|---|---|
| Water | 1620 | L |
| Boric acid | 5.6 | kg |
| Borax | 4.6 | kg |
| Ethyl alcohol | 44 | L |
| Cation polymer (P-2) 25% aqueous solution | 320 | L |
| Fluorescent whitening agent | 2.0 | L |
| aqueous solution (W1) | | |

The entire quantity is completed using 2000 liters of de-ionized water.

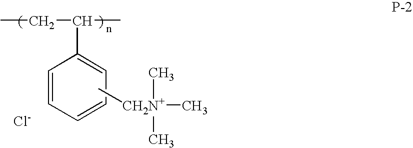

Silica dispersed liquid F was prepared by carrying out continuous dispersion using the dispersion method similar to that used in the Preferred Embodiment 1 using the same silica powder as that used in the Preferred Embodiment 1 and the above liquid E. The silica density in the obtained dispersed liquid is adjusted by adding de-ionized water so that the final value is 18% by weight of silica for a dispersion liquid of 1 liter, and the pH of the silica dispersed liquid was 4.3.

Preparation of the Coating Liquid:

The following four types of coating liquids G-J were prepared using the dispersed liquid B and the dispersed liquid F. The composition of the coating liquid is shown below as the share of the constituents per liter of the coating liquid.

Coating Liquid G:

| | | |
|---|---|---|
| Silica Dispersion Liquid B | 500 | ml |
| De-ionized water | 120 | ml |
| 8% Aqueous solution (by weight/volume) of polyvinyl alcohol | 210 | ml |
| (1:1 mixture of PVA 235/245 manufactured by Kuraray Co., | | |
| Ltd.) | | |
| Titanium Dioxide Dispersion Liquid 1 | 33 | ml |
| Acrylic Type Latex Emulsion Solution (*2) | 65 | ml |
| Polybutadiene dispersion liquid (*3) | 45 | ml |
| Surfactant (5% solution of SF-1) | 1.5 | ml |

Added de-ionized water to make up 1000 ml.
(*2) Acrylic Type Latex Emulsion: Acrylic Type Emulsion Dispersion Liquid with Tg ≈ −30° C. and emulsion polymerization in PVA 235 (acrylic type component = 30% by weight, PVA component = 5% by weight, average particle diameter of emulsion ≈ 0.15 μm).
(*3) Polybutadiene Dispersion Liquid: B3000 dispersion material manufactured by Japan Soda Corporation of the type of oil drops in water. Density of solid component = 15% by weight, average particle diameter ≈ 0.55 μm.

Coating Liquid H:

| | | |
|---|---|---|
| Silica Dispersion Liquid B | 560 | ml |
| De-ionized water | 120 | ml |
| 8% Aqueous solution (by weight/volume) of polyvinyl alcohol | 180 | ml |
| (1:1 mixture of PVA 235/245 manufactured by Kuraray Co., | | |
| Ltd.) | | |
| Acrylic Type Latex Emulsion Solution (*2) | 45 | ml |
| Polybutadiene dispersion liquid (*3) | 25 | ml |

Added de-ionized water to make up 1000 ml.

Coating Liquid I:

| | | |
|---|---|---|
| Silica Dispersion Liquid F | 560 | ml |
| De-ionized water | 170 | ml |
| 8% Aqueous solution (by weight/volume) of polyvinyl alcohol | 230 | ml |
| (1:1 mixture of PVA 235/245 manufactured by Kuraray Co., | | |
| Ltd.) | | |
| Acrylic Type Latex Emulsion Solution (*2) | 10 | ml |
| Added de-ionized water to make up 1000 ml. | | |
| Aqueous solution of zirconyl acetate (10%) (*4) | 40 | ml |

(*4) Mixed in the coating liquid I in the line immediately prior to coating (about 8 seconds before).

Coating Liquid J:

| | | |
|---|---|---|
| Silica Dispersion Liquid F | 560 | ml |
| De-ionized water | 120 | ml |
| 8% Aqueous solution (by weight/volume) of polyvinyl alcohol | 270 | ml |
| (1:1 mixture of PVA 235/245 manufactured by Kuraray Co., | | |
| Ltd.) | | |
| Surfactant (5% solution of SF-1) | 4 | ml |
| Aqueous solution of saponin (5%) | 15 | ml |

Added de-ionized water to make up 1000 ml.

The viscosities (Pa·s) at 40° C. and 15° C. of the above coating liquids G-J had the following values.

| Coating Liquid | 40° C. | 15° C. |
|---|---|---|
| G | 0.070 | 25.00 |
| H | 0.090 | 40.00 |
| I | 0.055 | 25.00 |
| J | 0.075 | 65.00 |

Each of the coating liquids obtained in the above manner are coated on the top surface of the aforementioned the four types of glossy supporting bodies having both sides coated with polyolefin resin similar to those explained in the Preferred Embodiment 5 in the sequence from the support side of the first layer (Coating Liquid G), the second layer (Coating Liquid H), the third layer (Coating Liquid I), and the fourth layer (Coating Liquid J) so that the wet film thicknesses of each layer is 42 μm and the coating temperature is 40° C., and the coating speed is 240 m/min using the curtain coating method. The drying conditions and the temperature of the support were same as those in the Preferred Embodiment 5. The liquid repelling defects of the obtained ink jet recording sheet were investigated and the results shown in Table 8 were obtained.

TABLE 8

| | | Temperature | | |
|---|---|---|---|---|
| | | difference | Number of | |
| | | between | liquid | |
| | Support | coating liquid | repelling | |
| Support | temperature | and support | defects | Remarks |
| RC-1 | 22° C. | (ΔT = 18) | 14.4 | Comparative |
| | | | | Example |
| | 30° C. | (ΔT = 10) | 4.6 | Comparative |
| | | | | Example |
| | 38° C. | (ΔT = 2) | 3.8 | Comparative |
| | | | | Example |
| | 45° C. | (ΔT = 5) | 3.2 | Comparative |
| | | | | Example |
| RC-2 | 22° C. | (ΔT = 18) | 10.2 | Comparative |
| | | | | Example |
| | 30° C. | (ΔT = 10) | 0.8 | Present |
| | | | | Invention |
| | 38° C. | (ΔT = 2) | 0.6 | Present |
| | | | | Invention |
| | 45° C. | (ΔT = 5) | 0.6 | Present |
| | | | | Invention |
| RC-3 | 22° C. | (ΔT = 18) | 9.6 | Comparative |
| | | | | Example |
| | 30° C. | (ΔT = 10) | 0.6 | Present |
| | | | | Invention |
| | 38° C. | (ΔT = 2) | 0.4 | Present |
| | | | | Invention |
| | 45° C. | (ΔT = 5) | 0.2 | Present |
| | | | | Invention |
| RC-4 | 22° C. | (ΔT = 18) | 9.4 | Comparative |
| | | | | Example |
| | 30° C. | (ΔT = 10) | 0.6 | Present |
| | | | | Invention |
| | 38° C. | (ΔT = 2) | 0.2 | Present |
| | | | | Invention |
| | 45° C. | (ΔT = 5) | 0.4 | Present |
| | | | | Invention |

From the results shown in Table 8, it is clear that the effect of the present invention can be obtained even when the porous ink absorption layer has a multilayer configuration.

### Preferred Embodiment 7

The Preferred Embodiment 7 was carried out by repeating the Preferred Embodiment 6 by increasing the coating liquid temperature from 40° C. to 46° C. The viscosities (Pa·s) of the above mentioned coating liquids G-J at 46° C. had the following values.

| Coating Liquid | 46° C. |
|---|---|
| G | 0.052 |
| H | 0.065 |
| I | 0.042 |
| J | 0.058 |

The results are shown in Table 9.

TABLE 9

| | | Temperature | | |
|---|---|---|---|---|
| | | difference | Number of | |
| | | between | liquid | |
| | Support | coating liquid | repelling | |
| Support | temperature | and support | defects | Remarks |
| RC-1 | 22° C. | (ΔT = 24) | 24.6 | Comparative |
| | | | | Example |
| | 30° C. | (ΔT = 16) | 10.2 | Comparative |
| | | | | Example |
| | 38° C. | (ΔT = 8) | 2.8 | Comparative |
| | | | | Example |
| | 45° C. | (ΔT = 1) | 2.4 | Comparative |
| | | | | Example |
| RC-2 | 22° C. | (ΔT = 24) | 20.4 | Comparative |
| | | | | Example |
| | 30° C. | (ΔT = 16) | 8.6 | Comparative |
| | | | | Example |
| | 38° C. | (ΔT = 8) | 0.6 | Present |
| | | | | Invention |
| | 45° C. | (ΔT = 1) | 0.6 | Present |
| | | | | Invention |
| RC-3 | 22° C. | (ΔT = 24) | 18.2 | Comparative |
| | | | | Example |
| | 30° C. | (ΔT = 16) | 7.4 | Comparative |
| | | | | Example |
| | 38° C. | (ΔT = 8) | 0.4 | Present |
| | | | | Invention |
| | 45° C. | (ΔT = 1) | 0.6 | Present |
| | | | | Invention |
| RC-4 | 22° C. | (ΔT = 24) | 17.2 | Comparative |
| | | | | Example |
| | 30° C. | (ΔT = 16) | 6.6 | Comparative |
| | | | | Example |
| | 38° C. | (ΔT = 8) | 0.4 | Present |
| | | | | Invention |
| | 45° C. | (ΔT = 1) | 0.4 | Present |
| | | | | Invention |

From the results shown in table 9, it is clear that it is possible to obtain good resistance to liquid repelling defects even when the temperature of the support is raised as long as the difference between the temperature of the support and the temperature of the coating liquid is maintained at 15° C. or less.

1. A method for manufacturing ink jet recording sheet comprising the steps, in that order, of:
providing an under-coat layer on a polyolefin coated support having the center-line average roughness of the surface of the polyolefin coated support of 0.10 to 1.5 μm as measured at a reference length of 2.5 mm and a cutoff value of 0.8 mm;
heating the polyolefin coated support on which the under-coat layer is provided; and
coating on the under-coat layer a coating liquid that contains inorganic micro particles and binder so that the coating liquid forms a porous ink absorption layer,
wherein the temperature difference between the temperature of the polyolefin coated support and the temperature of the coating liquid is within 15° C. in the coating step.

2. The method for manufacturing ink jet recording sheet of claim 1, the center-line average roughness is defined in JIS B 0601 Ra, wherein the Ra of the surface of the polyolefin coated support is 0.10 to 1.5 μm as measured at a reference length of 2.5 mm and a cutoff value of 0.8 mm.

3. The method of manufacturing ink jet recording sheet of claim 1, wherein the temperature of the coating liquid is in the range 35 to 50° C.

4. The method of manufacturing ink jet recording sheet of claim 1, wherein the mass ratio of the inorganic micro particles to the binder is in the range 3 to 8.

5. The method of manufacturing ink jet recording sheet of claim 1, wherein the coating speed in the coating step is 50 to 500 m per minute.

6. The method of manufacturing ink jet recording sheet of claim 1, further comprising the steps, after the coating step, of:
adjusting the temperature of the porous ink absorption layer so as not to be more than 20° C.; and
drying the temperature adjusted porous ink absorption layer.
